(19) United States
(12) Patent Application Publication
(10) Pub. No.: US 2004/0263357 A1
(43) Pub. Date: Dec. 30, 2004

(54) Vehicular monitoring system

(76) Inventor: John Hamilton, Baltimore, MD (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/841,341

(22) Filed: May 6, 2004

Related U.S. Application Data
(60) Provisional application No. 60/468,055, filed on May 6, 2003.

(51) Int. Cl. G08G 1/01

(52) U.S. Cl. 340/936

(57) ABSTRACT

A vehicular monitoring system that includes a brain box is described. The brain box is connected with a vehicle and transmits vehicular data obtained from a plate tag on a license plate to a mainframe located away from the vehicle. The system may have the license plate mounted on the brain box. The system may also have the plate tag be a bar code or a radio frequency tag. The system may also have the brain box include a plate scanner for obtaining the vehicular data from the plate tag, a central processing unit, a memory, and a transmitter. The central processing unit is in communication with the plate scanner and the memory is in communication with the central processing unit for storing the vehicular data. The transmitter is in communication with the central processing unit for transmitting the vehicular data to the mainframe.

### RELATED APPLICATION DATA

The present application claims priority to Provisional Application No. 60/468,055 filed May 6, 2003, which application is incorporated herein by reference to the extent permitted by law.

### BACKGROUND

The present invention relates generally to a vehicular monitoring system for monitoring vehicular movement through transmitting and receiving vehicular signals. The present invention also relates generally to a vehicular monitoring system including a vehicle transmitting and receiving device, an intelligent roadway and a central computer system.

Typically, extensive use of law enforcement personnel is required to monitor and regulate vehicular movement. For example, a law enforcement officer monitoring the speed of vehicles usually has to stake out a roadway using a device such as a radar gun to detect the speed of passing vehicles and spend time to observe the passing vehicles on the roadway and determine whether or not a vehicle is exceeding the speed limit. To issue a violation, the officer typically has to pull over the vehicle, gather information from the vehicle and the driver, and compare the information to a central database. Often times, the process is long and dangerous given the road or weather condition and the unknown driver or passengers in the vehicle.

Another area of monitoring and regulating vehicular movement done by Federal, State and local officials' administrations is determining whether a particular person is allowed to drive a vehicle, and determining whether a particular vehicle is allowed to be driven on the public roadways. The administrations gather information such as driver's license number, driver's name, address, date of birth, history of driver's records, and other relevant information.

However, problems may arise when officials try to enforce the legality of drivers. It can be difficult and time-consuming to track down an individual driver who has an expired driver's license or license plate. It also can be difficult to track down drivers without a valid driver's license or other illegal drivers. Additionally, in the area of security, a problem arises when law enforcement officials are trying to locate an illegal vehicle or an illegal driver in the processing of driving a vehicle. Close surveillance and monitoring of the vehicle or driver are required which also can be difficult and time-consuming.

It would be desirable to have a method and a device of monitoring vehicular movement to increase security and minimize any threats that take on a mobile character. Additionally, it would be desirable to have a method and a device for monitoring vehicular movement that is automated, up-to-date and accurate. The methods and systems in accordance with the present invention may revolutionize the safety and security of highways and byways.

### BRIEF SUMMARY

The present invention is defined by the following claims, and nothing in this section should be taken as a limitation on those claims. By way of introduction, one aspect of the present invention relates to a method for monitoring a vehicle. The method includes obtaining vehicular data from a plate tag on a license plate connected to a vehicle and transmitting the vehicular data from the vehicle to a mainframe located away from the vehicle. The method may also include storing the vehicular data in a brain box connected with the vehicle. The method may also include determining whether the vehicle is activated and transmitting the vehicular data once the vehicle is activated.

One aspect of the present invention relates to a vehicular monitoring system that includes a brain box. The brain box is connected with a vehicle and transmits vehicular data obtained from a plate tag on a license plate to a mainframe located away from the vehicle. The system may have the license plate mounted on the brain box. The system may also have the plate tag be a bar code or a radio frequency tag. The system may also have the brain box include a plate scanner for obtaining the vehicular data from the plate tag, a central processing unit, a memory, and a transmitter. The central processing unit is in communication with the plate scanner and the memory is in communication with the central processing unit for storing the vehicular data. The transmitter is in communication with the central processing unit for transmitting the vehicular data to the mainframe. The system may also have the brain box further include a receiver in communication with the central processing unit for receiving mainframe data from the mainframe.

These and other objects of the present invention will be classified in the following description of the preferred embodiment in connection with the drawings, the disclosure and the appended claims, wherein like reference numerals represent like elements throughout. The drawings constitute a part of this application and include exemplary embodiments of the present invention and illustrate various features thereof.

### BRIEF DESCRIPTION OF THE DRAWINGS

FIG. 1 depicts a vehicular monitoring system, in accordance with the present invention;

FIG. 2 depicts a flow diagram of a vehicular monitoring system, in accordance with the present invention;

FIG. 3 depicts a dashboard and a scanner of a vehicular monitoring system, in accordance with the present invention;

FIG. 4 depicts a driver's license used with a vehicular monitoring system, in accordance with the present invention;

FIG. 5 depicts an electronic license plate and a brain box of a vehicular monitoring system, in accordance with the present invention;

FIG. 6 depicts an enlarged view of the brain box shown in FIG. 5, in accordance with the present invention;

FIG. 7 depicts an enlarged view of the electronic license plate shown in FIG. 5, in accordance with the present invention;

FIG. 8 depicts an enlarged view of a traffic control device of a vehicular monitoring system attached to a road sign, in accordance with the present invention;

FIG. 9 depicts a vehicular monitoring system along with an intelligent roadway, in accordance with the present invention;

FIG. 10 depicts a flow diagram of a mainframe of a vehicular monitoring system, in accordance with the present invention; and

FIG. 11 depicts a flow diagram of a method for vehicular monitoring, in accordance with the present invention.

It should be appreciated that, for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DETAILED DESCRIPTION OF THE INVENTION

The presently preferred embodiments will now be described more fully hereinafter with reference to the accompanying drawings, in which the presently preferred embodiments are shown. This invention may be embodied in many different forms and should not be construed as limited to the embodiments set forth herein, rather, these embodiments are provided so that this disclosure will be thorough and complete and will fully convey the scope of the invention to those skilled in the art. Like numbers refer to like elements throughout.

As will be appreciated by one of skill in the art, the present invention may be embodied as a method, data processing system or program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code means embodied in the storage medium. Any suitable storage medium may be utilized including read-only memory (ROM), RAM, DRAM, SDRAM, magnetic storage devices such as hard disk drives and floppy disk drives, optical storage devices such as CD-ROMs and DVD-ROMs, and any other computer-readable storage medium.

Methods and devices consistent with the present invention provide an integrated vehicular monitoring system that improves the efficiency and security of the network of roadways. This system allows monitoring and tracking of vehicular movement of vehicles on roadways. The system can regulate the vehicles by receiving, generating, and transmitting data to and from a mainframe to control certain aspects of the vehicle, such as the vehicle's speed. The system allows for monitoring drivers who operate vehicles on the roadway and is able to issue citations for any infractions the driver may make. While methods and devices consistent with the present invention may apply to a variety of roadways and vehicles, they will be further described below with reference to the roadways and vehicles used in the United States to provide clarity, consistency, and to demonstrate the invention.

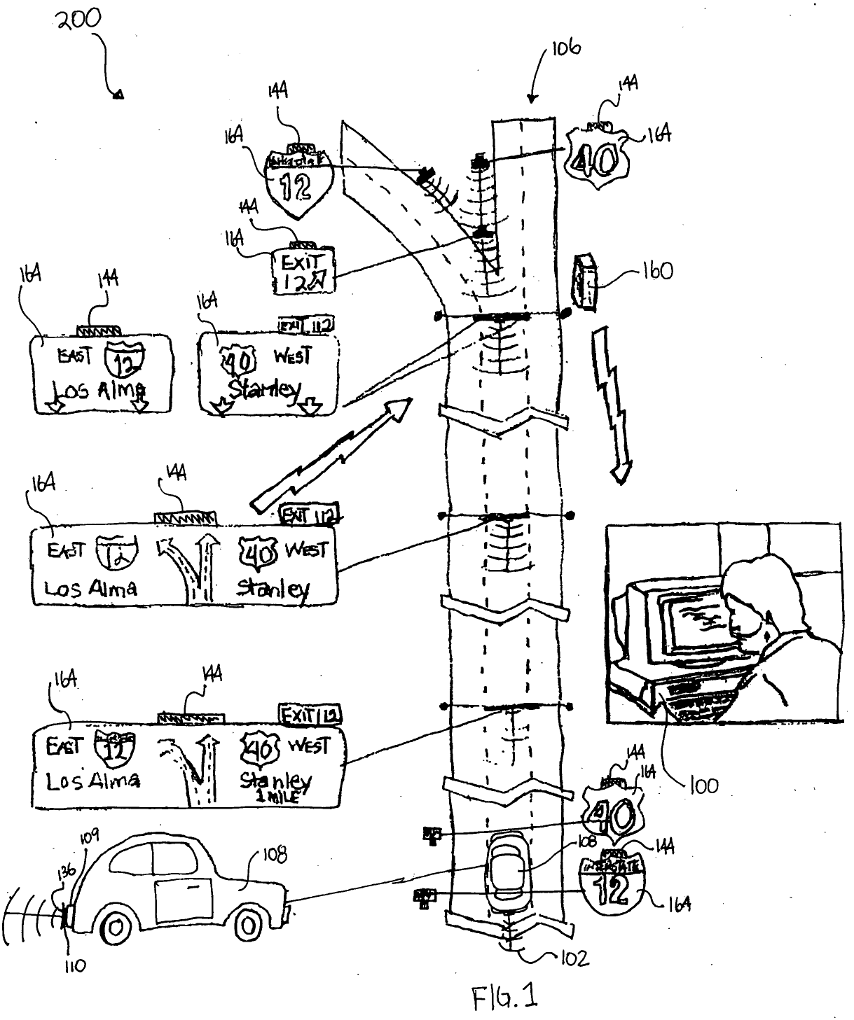

FIG. 1 depicts a vehicular monitoring system 200 having a brain box 110 connected with a vehicle 108, a traffic control device 144 located on an intelligent roadway 106 and in communication with the brain box 110, an electronic management station 160 located near the intelligent roadway 106, and a mainframe 100 located away from the vehicle 108.

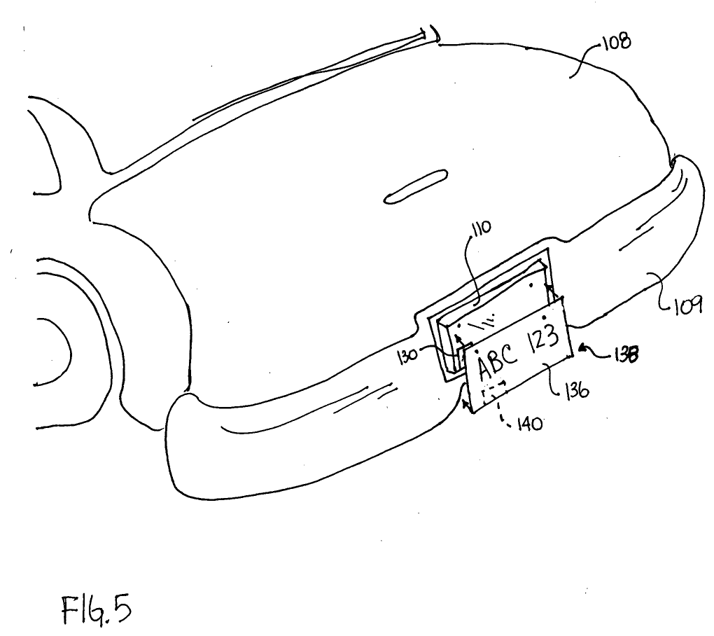

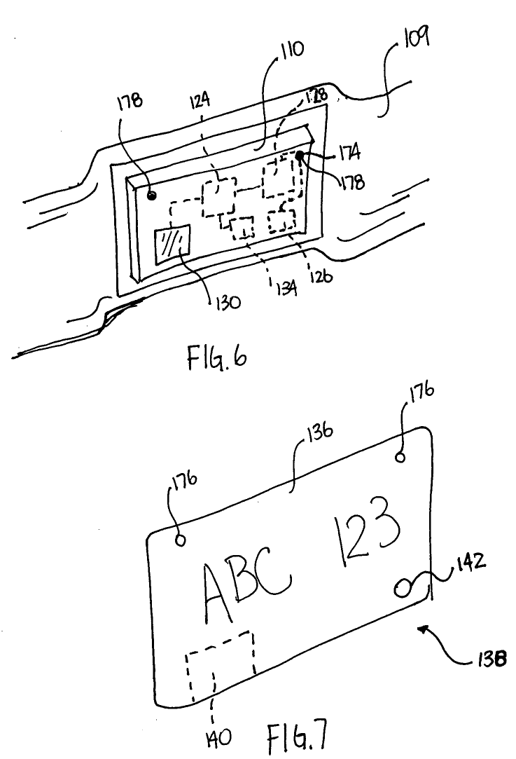

As illustrated in FIGS. 1, 5 and 6, the brain box 110 transmits local data 190, such as vehicular data 102 obtained from a plate tag 140 on a license plate 136, to a mainframe 100 located away from the vehicle 108. The brain box 110 also receives mainframe data 188 from the mainframe 100. The brain box 110 is an electronic device, such as a computer, which is attached to the vehicle 108 and receives local data 190 from a variety of devices located on or near the vehicle 108 and mainframe data 188 from a mainframe 100, as described below. The brain box 110 creates a line of communication between the vehicle 108 and the mainframe 100 that is designed to facilitate an environment that will be more conducive to the safety and security of a nation. The brain box 110 can be located on a bumper 109 of the vehicle 108 attached to and under a license plate 136, as illustrated in FIG. 5. The brain box 110 also can be located directly on the vehicle 108 without being attached to the license plate 136.

The brain box 110 has a central processing unit (CPU) 124, memory 134, a receiver 126, and a transmitter 128. In one embodiment, the brain box 110 includes the plate scanner 130, wherein the plate scanner 130 is attached to a part of the brain box 110. The CPU 124 can be any type of processor which can be used to receive and to execute data, such as an Intel Pentium Processor™ manufactured by Intel Corporation of Santa Clara, Calif. The CPU 124 is in communication with the receiver 126, the transmitter 128, the license scanner 112, the plate scanner 130, vehicular systems 170, and the memory 134. The CPU receives local data 190 from the license scanner 112, the plate scanner 130, and vehicular systems 170. Upon receiving the local data 190, the CPU 124 then saves the local data 190 in the memory 134 and transmits the local data 190, using the transmitter 128, to the mainframe 100. Memory 134 can be any type of computer-readable storage medium, as discussed above, and includes magnetic storage devices, optical storage devices, and dynamic memory such as random access memory (“RAM”) or any other device which can store computer-readable information and instructions which can be executed by the CPU 124. The memory 134 is used to store the mainframe data 188 and the local data 190 once received by the receiver 126. Upon storing the local data 190, the brain box 110 then may transmit the local data 190 to the mainframe 100, and more specifically, to the traffic control device 144.

The receiver 126 receives a wireless signal containing mainframe data 188. The receiver 126 is any device which can be used to receive a wireless signal and includes devices such as a cellular phone, an 802.11b receiver, a wireless network card, a radio, a radio-frequency receiver, an infrared receiver, and other such devices. Upon receiving a wireless signal containing mainframe data 188, the receiver 126 then sends the mainframe data 188 to the CPU 124. The transmitter 128 receives local data 190 and then transmits the local data 190 to the mainframe 100 in a wireless signal. The transmitter 128 may be any device which can be used to transmit a wireless signal and includes devices such as a cellular phone, an 802.11b transmitter, a wireless network card, a radio, a radio-frequency transmitter, an infrared transmitter, and other such devices.

In one embodiment, the brain box 110 includes a connector 174 which surrounds a brain box hole 178 and is electrically connected with the license plate 136. The connector 174 is also in communication with the transmitter 128, and therefore allows the transmitter 128 to effectively use the license plate 136 to transmit local data 190.

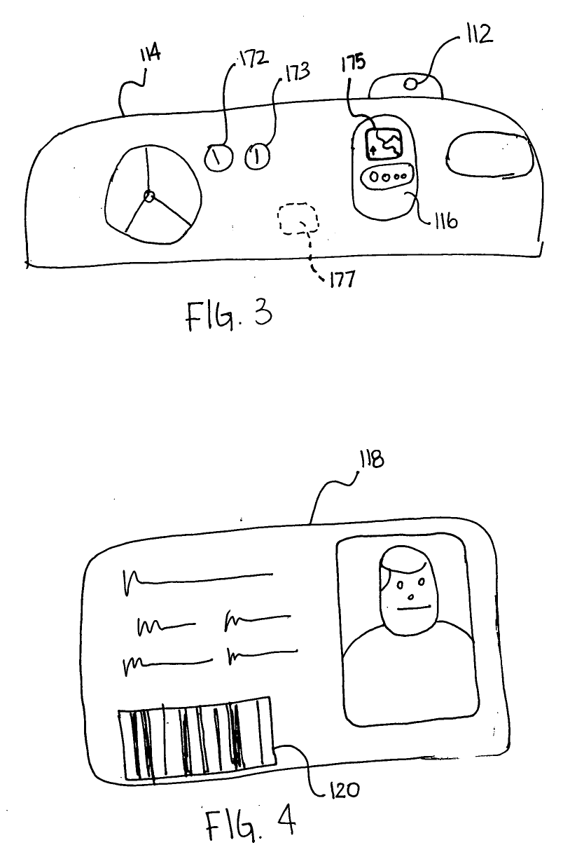

The brain box 110 communicates with a license scanner 112, a plate scanner 130, vehicular systems 170, and traffic control devices 144 to obtain various types of local data 190 which is generated locally by the vehicular systems 170, the plate scanner 130, the license scanner 112, and the traffic control device 144. The vehicular systems 170 are devices and/or systems located on the vehicle 108 that generate information about the vehicle 108, and include items such as a speedometer 172, a tachometer 173, an on board GPS unit 175, and a vehicle computer 177, as illustrated in FIG. 3. The local data 190 generated by the vehicular systems 170 is referred to as vehicular system data 171. The vehicular systems 170 all generate vehicular system data 171 which is then received by the brain box 110, and specifically the CPU 124. Upon receiving the local data 190, the brain box 110 then transmits the local data 190 to the mainframe 100.

The plate scanner 130 is a type of scanning device which is able to obtain information, such as vehicular data 102, from another device, such as a plate tag 140. The local data 190 generated or obtained by the plate scanner 130 is referred to as vehicular data 102. The plate scanner 130 can be any type of device which can be used to receive information, and includes such devices as RF receivers, RF scanners, IR scanner, laser scanners, optical scanners, and IR receivers. The plate scanner 130 obtains and/or generates vehicular data 102 which is then received by the brain box 110, and specifically the CPU 124. The vehicular data 102 contains information such as, but not limited to, a vehicle's identification number, a vehicle's owner, a vehicle's registration information, a vehicle's VIN number, a vehicle's owner registration information, preferably in chronological order, a vehicle's insurance company information, preferably in chronological order, and the type of insurance coverage for the vehicle 108, and other such information about the vehicle 108. Upon receiving the vehicular data 102, the brain box 110 then saves the vehicular data 102 in the memory 134 and transmits the vehicular data 102 to the mainframe 100.

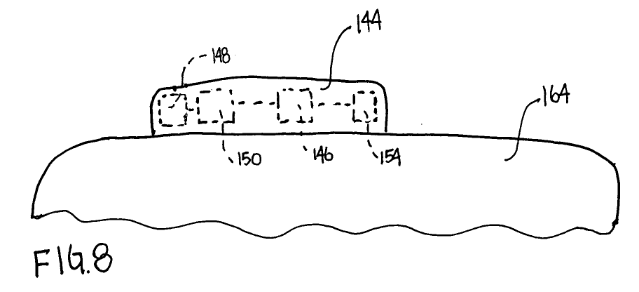

The plate scanner 130 obtains vehicular data 102 from an electronic license plate 138, as illustrated in FIGS. 5-7. Preferably, the electronic license plate 136 is mounted on the brain box 110. FIG. 5 and 7 depict an electronic license plate 138. The electronic license plate 138 has a license plate 136 with a plate tag 140 affixed to the backside of the license plate, as illustrated in FIG. 7. Specifically, the plate scanner 130 obtains the vehicular data 102 from the plate tag 140. The plate tag 140 contains the vehicular data 102 which is information about the vehicle 108. The plate tag 140 may be any device which can store information which may later then be retrieved and includes devices such as a bar code or a radio frequency tag.

The license scanner 112 is a type of scanning device which is able to obtain information, such as driver data 184, from another device, such as a driver's license 118, as illustrated in FIGS. 3-4. The local data 190 generated or obtained by the license scanner 112 is referred to as driver data 184. The license scanner 112 can be any type of device which can be used to receive information, and includes such devices as RF receivers, RF scanners, IR scanner, laser scanners, optical scanners, and IR receivers. The license scanner 112 obtains and/or generates driver data 184 which is then received by the brain box 110, and specifically the CPU 124.

Preferably, the driver's license 118 includes a license tag 120, which can be located anywhere on the driver's license 118. Specifically, the license scanner 112 obtains the driver data 184 from the license tag 120. The license tag 120 contains driver data 184 which is information about the driver of the vehicle 108. The license tag 120 may be any device which can store information which may later then be retrieved and includes devices such as a bar code or a radio frequency tag. The driver data 184 contains information such as, but not limited to, a driver's license number, a driver's name, address, and personal information, and other such information about the driver of the vehicle 108.

The license scanner 112 is located in the vehicle 108 for obtaining the driver data 184 from a license tag 120 located on a driver's license 118, wherein the license scanner 112 is in communication with the central processing unit 124. In one embodiment, the license scanner 112 is connected to the dashboard 114 of the vehicle 108, as illustrated in FIG. 3. As depicted in FIG. 3, the license scanner 112 is located on the dashboard 114 of a vehicle 108. However, the license scanner 112 is not limited to being located on the dashboard 114 of a vehicle 108, it can also be connected anywhere in the vehicle 108, such as within the radio 116.

The license scanner 112 is able to obtain driver data 184 from the license tag 120 with each vehicle 108 in operation by scanning the contents of the license tag 120 on the driver's license 118 into the license scanner 112. Upon activating the vehicle 108, a driver then can scan in his or her driver's license 118 which has a license tag 120 into the license scanner 112. The license scanner 112 then receives the driver data 184 from the license tag 120. Once the license scanner 112 receives the driver data 184, the license scanner 112 then transmits the driver data 184 to the brain box 110 where the driver data 184 is then stored.

In one embodiment, the vehicle 108 cannot start without having the license scanner 112 scan the driver's license 118. In this embodiment, the driver data 184 on the driver's license 118 is received by the brain box 110, which then transmits the driver data 184 to the mainframe 100 where the driver data 184 is then checked against a database 280 in the mainframe 100. If the driver's license 118 and the vehicle 108 have been granted clearance by the mainframe 100, the brain box 110 is given an ignition start procedure code which is sent from the mainframe 100 to the brain box 110 which allows the vehicle 108 to start. Once the vehicle 108 has been started the brain box 110 sends the driver data 184 back to the mainframe 100 where the mainframe 100 then issues an active operating status code indicating that the vehicle 108 may operate. Upon shutting the vehicle 108 off, the mainframe 100 then removes the active operating status code indicating that the vehicle 108 may operate.

In one embodiment, the driver's license 118 is coupled to the license scanner 112 when the vehicle 108 is in operation and then removed from the license scanner 112 when the vehicle 108 is in a parked position or shut off. Once the vehicle 108 is shut off or deactivated, the brain box 110 acknowledges the shut off and sends a deactivation code with the driver data 184 to the mainframe 100, wherein the mainframe 100 then removes the active operating status code indicating that the vehicle 108 may operate.

Upon receiving the local data 190, the brain box 110 stores the local data 190 in the memory 134. In one embodiment, the brain box 110 includes a clock (not shown) which allows the brain box 110 to store a time code in the memory 134. The time code may include the date, day, and time which is adjustable to any time zone at which the local data 190 was received by the brain box 110. For example, in the United States, the time stored would be adjusted to Eastern, Central, Mountain and Daylight savings time. Upon storing the local data 190, the brain box 110 then may transmit the local data 190 along with the time code to the mainframe 100 and, more specifically, to the traffic control device 144.

The brain box 110 also receives mainframe data 188 from the mainframe 100. Mainframe data 188 is data generated by the mainframe 100 which is in response to the mainframe 100 receiving data, such as local data 190. Mainframe data 188 may include a speed reduction shutdown sequence that instructs the vehicle computer 177 to reduce the speed of the vehicle 108 in order to assist the authorities in apprehending individuals involved in high speed chases. Mainframe data 188 may also include an ignition start procedure sequence which provides instructions to the vehicle 108 allowing the vehicle 108 to operate. The mainframe data 188 may include a notification of an infraction which notifies the driver than an infraction has occurred. The notification of an infraction may be stored in the brain box 110 along with other data. The mainframe 110 may include a vehicle deactivation control sequence for shutting off the vehicle 108. Once the vehicle deactivation control sequence is received by the brain box 110, the brain box 110 may send instructions to a vehicular system 170, such as the vehicle computer 177 to deactivate the vehicle 108 so that the vehicle 108 cannot be started. By preventing the vehicle 108 from being started, the vehicular monitoring system 200 is able to prevent unauthorized drivers from driving the vehicle 108. Mainframe data 188 may also include additional types of information or commands which may be used to control the vehicle 108 or various systems within the vehicle 108.

The brain box 110 can receive local data 190 on a variety of types of items. For example, the brain box 110 may receive local data 190 which indicates a tachometer 173 or speedometer 172 reading, an account of the total miles traveled by the vehicle 108, the number of accidents that the vehicle 108 has been in, and information about vehicles involved in accidents with vehicle 108 listed in chronological order. The brain box 110 also may receive local data 190 from the license scanner 112, the plate scanner 130, or the traffic control device 144 regarding the number of vehicle infractions the vehicle 108 has been in or the number of infractions made by the driver in chronological order, the number of driver's licenses that have been scanned and stored in chronological order, and the number of roadways traversed in chronological order, listed with county, city, and state code.

The brain box 110 may also receive local data 190, such as location data 168, from the traffic control devices 144, which contains information as to the precise location of the vehicle 108. For example, the traffic control devices 144 may each transmit location data 168 which contains information about the precise location of the traffic control devices 144. The traffic control devices 144 transmit the location data 168 using a short range transmitter, having a range of less than 50 feet, for example, and then the location data 168 is received by the brain box 110, stored in the memory 134, and then transmitted to the mainframe 100. Preferably, all of the local data 190 is stored in the brain box memory 134.

Upon storing the local data 190, the brain box 110 will then transmit the local data 190 to the mainframe 100. The local data 190 is actually transmitted to the traffic control devices 144 and then the traffic control devices 144 transmit the local data 190 to the electronic management station 160. Upon receiving the local data 190, the electronic management station 160 stores the local data 190 in a storage device for backup and then transmits the local data 190 to the mainframe 100.

The mainframe 100 has the ability to cross reference the local data 190 with already stored data and then transmit mainframe data 188 or issue a citation in response. The mainframe data 188 is transmitted by the mainframe 100 to the brain box 110, causing the brain box 110 to issue commands. For example, the mainframe 100 has the ability to transmit mainframe data 188 which would include a shutdown sequence to vehicles that have been cited for insurance cancellation, unpaid citations and suspended license. The shutdown sequence is transmitted to the vehicle 108 and then the brain box 110 may issue a command preventing the vehicle 108 from operating or starting when the vehicle 108 is not in use. For example, when the vehicle 108 has been parked for more than a certain amount of time, the brain box 110 may then instruct the vehicle's computer 177 to prevent the vehicle 108 from being started. Upon receiving such a command, the vehicle 108 then will fall into a no-start status in the mainframe 100 and the mainframe 100 will issue commands within the mainframe data 188 that can prevent the vehicle 108 from being started. Upon the lifting of a suspension or revocation, a user can access the mainframe 100 and remove the driver from the suspension or revocation list, causing the mainframe 100 to transmit mainframe data 188 which would include an ignition start processes which would allow the vehicle 108 to become operational again.

In one embodiment, the brain box 110 receives and stores mainframe data 188, such as the following types of mainframe data 188: ignition start and no start signals, speed reduction shut down sequences, road infractions, such as speeding and impeding traffic, running stop signs and accidents. Road infractions may be noted as follows: the date, the day, the time, the road identification code, the city, the county and the state code, the scanner driver's license, the vehicle identification number, the tachometer and the speedometer reading, and the type of infractions.

In one embodiment, the brain box 110 is connected with the electronic license plate 138. In this embodiment, the electronic license plate 138 transmits and receives data to and from the mainframe 100. The electronic license plate 138 then can store the data received in the memory 134. The electronic license plate 138 also can have an indicator light 142. When the brain box 110 receives a warning data or a traffic infraction data from the mainframe 100, the brain box 110 can then transmit a signal to the indicator light 142 to activate the indicator light 142. Once activated, the indicator light 142 may blink or flash a warning signal. The indicator light 142 may be used to alert authorities and bystanders that the vehicle 108 is in trouble. The authorities then can pull the vehicle 108 over for further inspection. Additionally, the indicator light 142 may be activated by the brain box 110 when it is determined that the vehicle speed exceeds the speed limit. For example, the brain box 110 may received road data 186 indicating the current speed limit the vehicle 108 is allowed to travel from the mainframe 100. Upon the receiving road data 186 indicating the current speed limit, the brain box 110 may then compare the road data 186 with vehicular system data 171 received from a vehicular system 170, such as a speedometer 172, and then determine whether or not the vehicle 108 is in excess of the current speed limit. If the vehicle 110 is in excess of the current speed limit, the brain box 110 may then activate the indicator light 142 to indicate to others that the vehicle is in violation of some law, in this case, the law governing the speed limit of a vehicle.

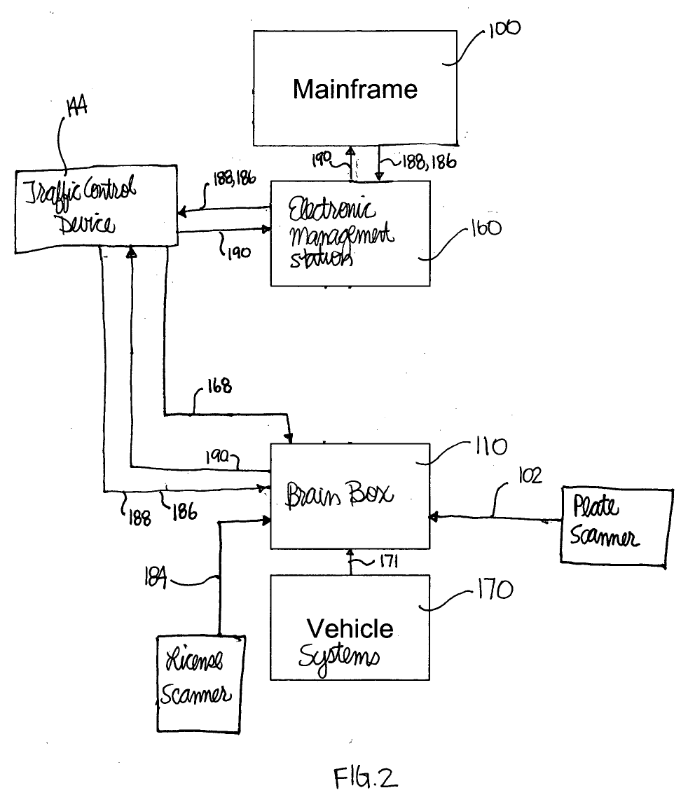

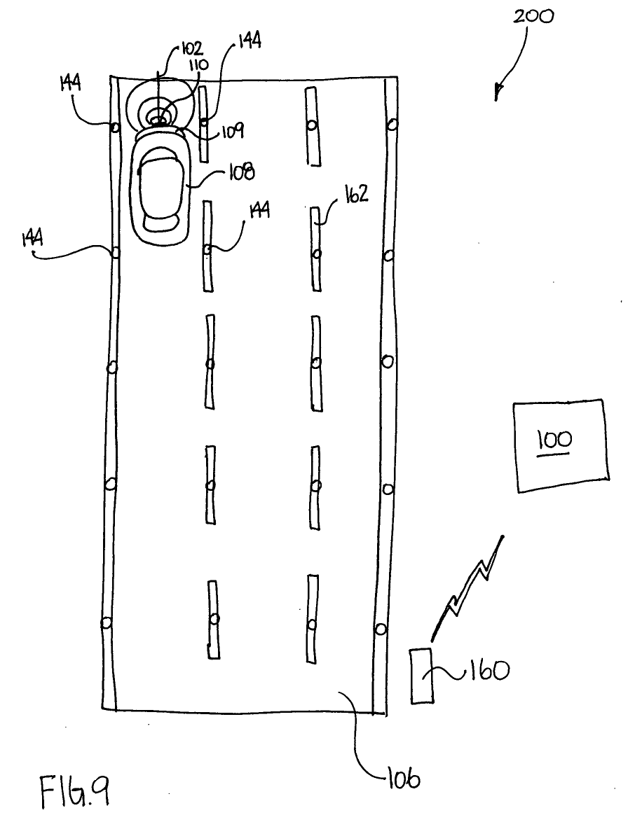

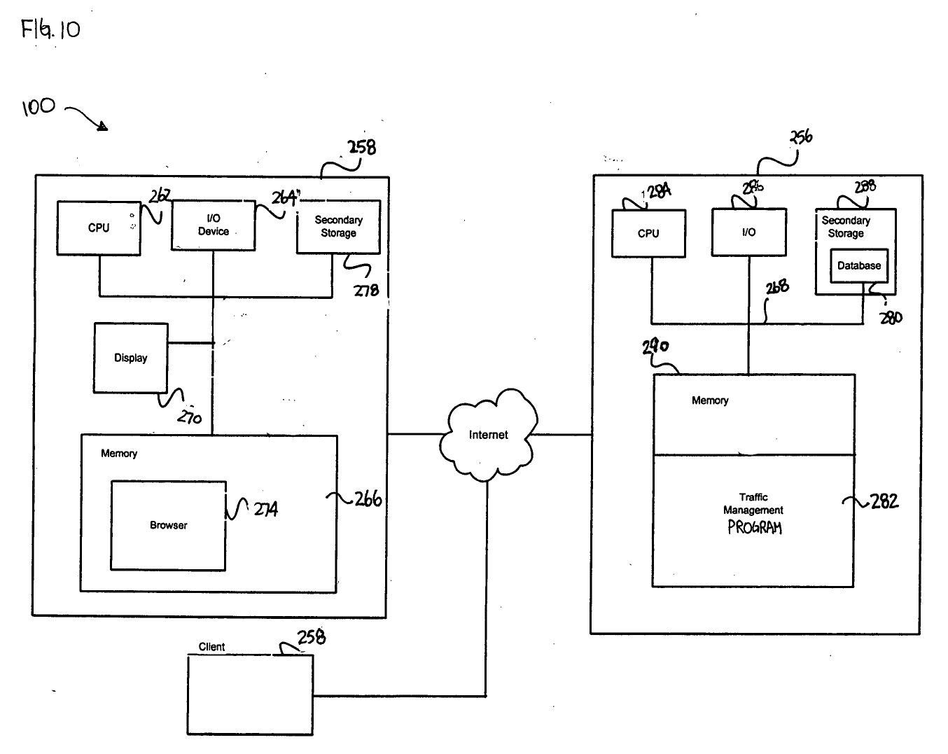

The traffic control device 144 is shown in FIGS. 1, 8, and 9. The traffic control device 144 receives local data 190 from the brain box 110 and transmits the local data to the electronic management station 160, which then transmits the local data 190 to the mainframe 100. Additionally, the traffic control device 144 generates location data 168 which is transmitted to and received by the brain box 110, in order to determine the location and the speed of the vehicle 108. In one embodiment, a plurality of traffic control devices 144 are embedded in the intelligent roadway 106, as illustrated in FIG. 9, to form a grid. In one embodiment, a plurality of traffic control devices 144 are attached to road signs 164, as illustrated in FIGS. 1 and 8. Preferably, the traffic control device 144 includes a CPU 146 in communication with a receiver 148 and a transmitter 150. In one embodiment, the traffic control device 144 includes a memory 154 for storing data. The traffic control device 144 also receives mainframe data 188 from the mainframe 100 and transmits the mainframe data 188 to the brain box 110. In one embodiment, the traffic control device 144 receives road data 186 from the mainframe 100. The road data 186 details road condition information, weather information, and speed adjustment information for adjusting the speed of a vehicle 108 in response to road conditions. The road data 186 is received by the traffic control device 144 and then transmitted to the brain box 110, as illustrated in FIG. 2.

FIGS. 1 and 9 depict traffic control devices 144 near or on an intelligent roadway 106. An intelligent roadway 106 is any roadway that has been set up with a traffic control device 144. In one embodiment, the traffic control device 144 can be built anywhere in or on lane markers 162 located on the intelligent roadway 106, placed alone alongside the intelligent roadway 106, or attached to road signs 164 along the intelligent roadway 106.

The traffic control device 144 receives vehicular data 102 from the vehicle 108 and transmits the vehicular data 102 to the mainframe 100 for any vehicle 108 that the mainframe 100 has assigned an identification code. The identification code is a code given to any vehicle 108 that is registered with the mainframe 100. This is similar to a vehicle identification number. It can be assigned at the manufacturing of the vehicle 108. The traffic control device 144 also receives and transmits road data 186 from the mainframe 100 to vehicles on the intelligent roadway 106. The traffic control device 144 may also transmit location data to the mainframe 100, as well. The mainframe 100 may generate and transmit road data 186 containing information about road conditions, such as the regulated speed limit, back to the traffic control device 144. The regulated speed limit may be stored in the mainframe 100. In one embodiment, the traffic control device 144 can be strategically located in different sites, such as construction zones, on school buses, or in a location where the speed of the roadway has to be reduced for safety and vehicles need to be monitored.

The electronic management station 160 is in communication with the traffic control device 144. The electronic management station 160 receives local data 190 from the traffic control device 144 and transmits the local data 190 to the mainframe 100. The electronic management station 160 also receives and transmits road data 186 and mainframe data 188 from the mainframe 100 to the traffic control device 144, which then transmits the road data 186 and the mainframe data 188 to the brain box 110. The electronic management station 160 comprises memory 154 and is in communication with the brain box 110. The electronic management station 160 stores brain box data 190 received from the brain box 110 in the memory 154. In one embodiment, the electronic management station 160 can be strategically located in selected intersections governing several communities. The electronic management station 160 receives, transmits and stores data, such as local data 190, for the vehicular monitoring system 200, monitors and records all communications between vehicle brain box 110, the traffic control devices 144 and the mainframe 100. The electronic management station 160 can keep a back up record of all the local data 190 for all the vehicles 108 in a given perimeter. The electronic management station 160 can also monitor a certain parameter, to safeguard the vehicular monitoring system 200 with several different system checks between the electronic management station 160 and the mainframe 100 and to keep the date, day and time regulated by the mainframe 100 synchronized with the brain box 110 and the traffic control devices 144.

As further explained herein, the mainframe 100 issues and adjusts data for eventualities. The mainframe 100 may hold a copy of motor vehicle administration records and laws from each state in a storage device, creating a national directory of official information that can be accessed by the proper authorities for the safety and security of our highways and byways, keeping an accurate account of licensee and permit holders as well as registration information, vehicle identification numbers and insurance information and classification.

The mainframe 100 is in constant communication with the traffic control device 144, the electronic management station 160, and the brain box 110 in the vehicle 108. The mainframe 100 has the ability to collect local data 190, such as vehicular data 102, from a vehicle at rest or in operation, as well as being able to log vehicle infractions. The brain box 110 transmits vital information such as a vehicle's speed, weather conditions, road conditions, and any infractions that may occur in a vehicle. The mainframe 100 is the central operating system of monitoring vehicular movement in conjunction with Federal, State, local or any other national authorities.

FIG. 2 depicts a flow chart of how information is received and transmitted from the mainframe 100. The mainframe 100 may include a network of computers that store information and software that assists government agencies in the daily operation of the first safety and security system that monitors all vehicular activity, create a profile of driver behavior patterns, e.g., drunk drivers, red light runners, stop sign runners, outstanding warrant holders, and conduct other activates. The mainframe 100 assists, regulates, and manages the public accessibility of our roadways. The mainframe 100 creates a virtual identity for the driver, vehicle and roadway which allows the date, day and time to create a virtual state of eventualities that is recorded by the computer system and stored in its memory.

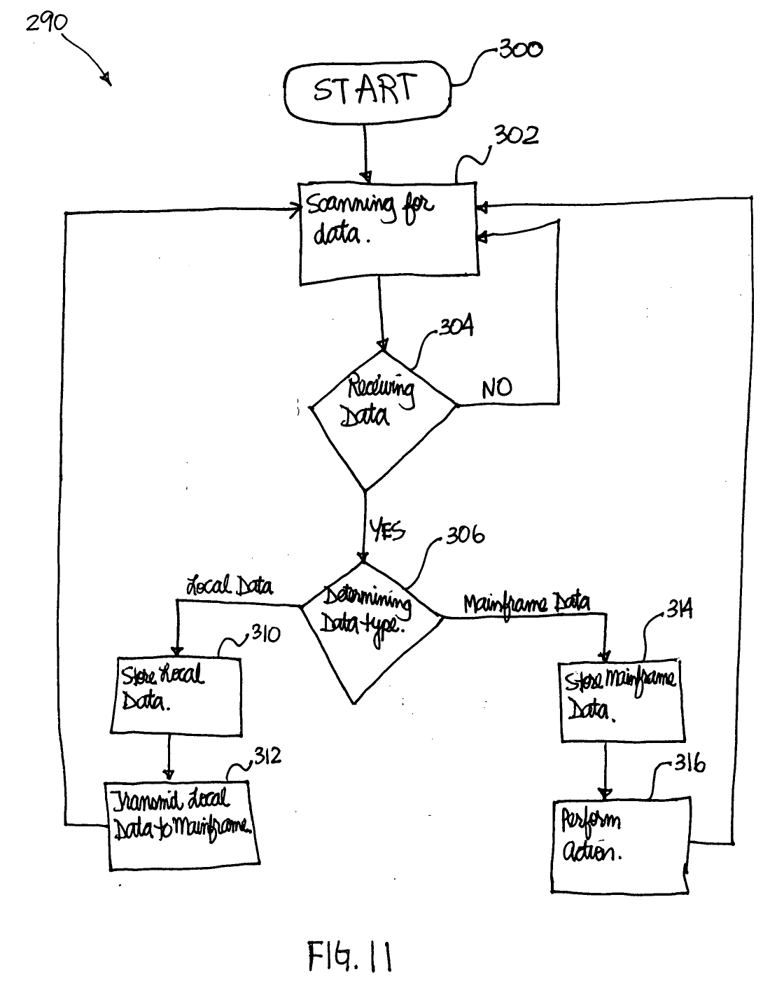

FIG. 10 depicts an exemplary data processing system suitable for use in accordance with methods and systems consistent with the present invention. FIG. 10 illustrates a mainframe 100. The mainframe 100 can have two client computers 258 and a server computer 256 connected to a network such as the Internet, and either computer may represent any kind of data processing device, such as a general-purpose data processing device, a personal computer, a plurality of interconnected data processing devices, a brain box, an electronic control device, a mainframe, a mobile computing device, a personal data organizer, a mobile communication device including mobile telephones or similar devices. The clients 256 and server 258 may represent computers in a distributed environment, such as on the Internet or traffic control network. There may also be many more clients 258 and servers 256 than shown in FIG. 10.

A client 258 includes a central processing unit (“CPU”) 262, an input-output (“I/O”) unit 264 such as a mouse or keyboard, and a memory 266 such as a random access memory (“RAM”) or other dynamic storage device for storing information and instructions to be executed by the CPU 262. The client 258 also includes a secondary storage device 278 such as a magnetic disk or optical disk that may communicate with each other via a bus 268 or other communication mechanism. The client 258 also may include a display 270 such as a cathode ray tube (“CRT”) or LCD monitor. Although aspects of methods and systems consistent with the present invention are described as being stored in a memory 272, one having skill in the art will appreciate that all or part of methods and systems consistent with the present invention may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of the data processing system are described, one skilled in the art will appreciate that a data processing system suitable for use with methods, systems, and articles of manufacture consistent with the present invention may contain additional or different components. The client 258 may include a human user or may include a user agent. The term “user” may refer to a human user, software, hardware or any other entity using the system.

As shown, the memory 272 in the client 258 may include a browser 274 which is an application that is typically any program or group of application programs allowing convenient browsing through information or data available in distributed environments, such as the Internet or any other network including local area networks. A browser 274 generally allows viewing, downloading of data and transmission of data between data processing devices. The browser 274 may also be other kinds of applications and may allow an electronic control device to connect to a central computer.

Although only one browser 274 is shown, any number of browsers may be used. Additionally, although shown on the client 258 in the memory 266, these components may reside elsewhere, such as in the secondary storage 278, or on another computer, such as another client 258. Furthermore, these components may be hardware or software whereas embodiments in accordance with the present invention are not limited to any specific combination of hardware and/or software.

FIG. 10 also depicts a server 256 that includes a CPU 284, an I/O unit 286, a memory 290, and a secondary storage device 288 having a database 280 that communicate with each other via a bus 268. The server may act as a traffic management central computer. The memory may store a traffic management program 282 which manages the functions of the server and interacts with the database 280. The database 280 may store information pertaining to vehicle registrations, vital statistics, speed limits, traffic violations, driver's licenses, locations, times, VINs, associated video files, audio files, etc. The database 280 may also reside elsewhere, such as in a memory 290. The server 256 may also have many of the components mentioned in conjunction with the client 258. There may be many servers 256 working in conjunction with one another. The traffic management program 282 may be implemented in any way, in software or hardware or a combination thereof, and may be distributed among many computers. It may be represented by any number of components, processes, threads, etc.

The client 258 and server 256 may communicate directly or over networks, and may communicate via wired and/or wireless connections or any other method of communication. Communication may be done through any communication protocol, including known and yet to be developed communication protocols. The network may comprise many more clients 258 and servers 256 than those shown on the figure, and the client 258 and server 256 may also have additional or different components than those shown.

The mainframe 100 receives local data 190 from the brain box 110 and compares the local data 190 to data found within the database 280. Data can also be directly input into the mainframe 100. The mainframe 100 stores the local data 190 into memory. In one embodiment, the mainframe 100 can automatically issue a citation, such as a speeding ticket, upon receiving the local data 190. The citation could be sent directly to the driver without the use of law enforcement officers. In another embodiment, a mobile device may be set up in a police squad vehicle to access the mainframe 100. The officer then can pull up photo driver license and driving record of the individual in question and request that the mainframe 100 send mainframe data 188 to the brain box 110, in order to, for example, slow down or shut off a vehicle 108.

The database 280 within the mainframe 100 can hold a number of items. In one embodiment, the database 280 is a national database of active driver's license and vehicle vitals, monitoring drug trafficking, keeping an actual count of cars on the roadway and the number of cars that are from another state, tracking stolen vehicles, eliminating high speed chases with the vehicle reduction shut down sequence, assisting with solving attacks on citizens where a vehicle is involved, and reducing the number of aggressive drivers and vehicular homicides.

In operation, the vehicular monitoring system 200 transmits local data 190, such as the vehicular data 102 obtained from the plate tag 140 on the license plate 136, to the mainframe 100 located away from the vehicle 108. The vehicular monitoring system 200 also stores the local data 190 in the brain box 110 connected with the vehicle 108. The vehicular monitoring system 200 may also transmit local data 190, such as driver data 184 obtained from a license tag 120 on a driver's license 118, to the mainframe 110 which is located away from the vehicle 108.

The vehicular monitoring system 200 is capable of determining whether the vehicle 108 is activated and if the vehicle 108 is activated, the brain box 110 is able to transmit local data 190, such as vehicular data 102, to the mainframe 100. The vehicular data 102 may include a vehicle identification number, a driver's license number, a driver identity information, or insurance information. Vehicular system data 171 may be obtained from a vehicular system 170 connected to the vehicle 108. The vehicular system data 171 comprises vehicle speed data. The vehicular monitoring system 200 stores the vehicular system data 171 into the brain box 110.

The vehicular monitoring system 200 may also determines whether the vehicle 108 is in motion. If the vehicle 108 is in motion, then the brain box 110 is able to obtain vehicular system data 171 and then transmit the vehicular system data 171 to the mainframe 100. The brain box 110 receives road data 186 from the mainframe 100. The road data 186 indicates information about the intelligent roadway 106, such as current road conditions and the speed limit of the intelligent roadway 106 at particular points along the roadway 106. The brain box 110 then stores the road data 186. The road data 186 may also includes location and weather information, road condition information, or traffic infraction information.

The mainframe 100 can determine whether the vehicle 108 exceeds the speed limit by comparing data regarding the vehicle's speed which is received from a vehicular system 170 to the road data 186 stored within the database 280. If it is determined that the vehicle speed exceeds the speed limit, the vehicular monitoring system 200 activates an indicator light 142. The brain box 110 may receive mainframe data 100 that comprises a notification of an infraction data or a vehicle speed control data. The brain box 110 then adjusts the vehicle speed upon receiving the vehicle speed control data.

When the brain box 110 determines that the vehicle 108 is deactivated, the brain box 110 may receive additional mainframe data 100 which comprises a notification of an infraction data or vehicle deactivation control data. When the brain box 110 obtains vehicle deactivation control data a deactivation sequence is transmitted to deactivate the vehicle 108.

FIG. 11 is a flowchart illustration of methods, apparatus (systems) and computer program products according to the invention. It will be understood that each block of the flowchart illustrations, and combinations of blocks in the flowchart illustrations, can be implemented by computer program instructions. These computer program instructions may be loaded onto a computer or other programmable data processing apparatus to produce a machine, such that the instructions which execute on the computer or other programmable data processing apparatus create means for implementing the functions specified in the flowchart block or blocks. These computer program instructions may also be stored in a storage medium that can direct a computer or other programmable data processing apparatus to function in a particular manner, such that the instructions stored in the storage medium produce an article of manufacture including instruction means which implement the function specified in the flowchart block or blocks. The computer program instructions may also be loaded onto a computer or other programmable data processing apparatus to cause a series of operational steps to be performed on the computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer instructions.

As seen in FIG. 11 a vehicular monitoring operation 290 for a vehicular monitoring system 200 is initiated in block 300. The start operation in block 300 activates the brain box 110. Upon activating the brain box 110, the brain box 110 begins to scan for data, such as local data 190 and mainframe data 188, as shown in block 302. If data is found, the brain box 110 determines whether the data can be received, as shown in block 304. If data is received, then the vehicular monitoring operation 290 moves to block 306, and if data is not received then the vehicular monitoring operation 290 moves back to block 302 and continues to scan for data. At block 306, the vehicular monitoring operation 290 determines whether the data received was local data 190 or mainframe data 188. If the data received was local data 190, then the vehicular monitoring operation 290 moves to block 310, wherein the brain box 110 stores the local data 190 in memory 134. Upon storing the local data 190 in memory 134, the brain box 110 then transmits the local data 190 to the mainframe 100, as shown in block 312. Upon transmitting the local data 190 to the mainframe 100, the vehicular monitoring operation 290 moves to block 302 and continues to scan for data. If the data received was mainframe data 188, then the vehicular monitoring operation 290 moves to block 314, wherein the brain box 110 stores the mainframe data 188 in memory 134. Upon storing the mainframe data 188 in memory 134, the brain box 110 then performs an action, such as shutting off the vehicle 108, slowing down the vehicle 108, or activating the indicator signal 142 on the vehicle 108. Upon performing an action, the vehicular monitoring operation 290 moves to block 302 and continues to scan for data.

Although the foregoing detailed description of the present invention has been described by reference to one or more exemplary embodiments, and the best mode contemplated for carrying out the present invention has been shown and described, it will be understood that modification or variations in the structure and arrangement of this embodiment other than those specifically set forth herein may be achieved by those skilled in the art and that such modifications are to be considered as being within the overall scope of the present invention. Therefore, it is contemplated to cover the present invention and any and all modifications, variations, equivalents that fall within the true spirit and scope of the underlying principles disclosed and claimed herein. Consequently, the scope of the present invention is intended to be limited only by the attached claims.

1. A method for monitoring a vehicle comprising:
obtaining vehicular data from a plate tag on a license plate connected to a vehicle; and
transmitting the vehicular data from the vehicle to a mainframe located away from the vehicle.

2. The method of claim 1 further comprising storing the vehicular data in a brain box connected with the vehicle.

3. The method of claim 1 further comprising determining whether the vehicle is activated and transmitting the vehicular data once the vehicle is activated.

4. The method of claim 3 further comprising obtaining vehicular system data from a vehicular system connected to the vehicle.

5. The method of claim 4, wherein the vehicular system data comprises data regarding the vehicle's speed.

6. The method of claim 4 further comprising storing the vehicular system data into the brain box.

7. The method of claim 4 further comprising determining whether the vehicle is in motion; and obtaining the vehicular system data once the vehicle is in motion.

8. The method of claim 1 further comprising receiving road data from the mainframe, wherein the road data indicates the speed limit.

9. The method of claim 8 further comprising storing the road data into the brain box.

10. The method of claim 8 further comprising determining whether the vehicle exceeds the speed limit by comparing data received from a vehicular system to the road data.

11. The method of claim 10 further comprising activating an indicator light when it is determined that the vehicle speed exceeds the speed limit.

12. The method of claim 1 further comprising receiving mainframe data.

13. The method of claim 12, wherein the mainframe data comprises a notification of an infraction data or data with information about a speed limit.

14. The method of claim 13, further comprising adjusting the vehicle speed upon receiving the data with information about a speed limit.

15. The method of claim 1 further comprising determining whether the vehicle is deactivated and receiving mainframe data when it is determined that the vehicle is deactivated.

16. The method of claim 15, wherein the mainframe data includes a notification of an infraction or vehicle deactivation control sequence for shutting off the vehicle.

17. The method of claim 1 further comprising transmitting local data from the vehicle to a mainframe located away from the vehicle.

18. A method for vehicular monitoring according to claim 1, wherein the vehicular data comprises a vehicle identification number.

19. A method for vehicular monitoring according to claim 8, wherein the road data further comprises location information, weather information, road condition information, or traffic infraction information.

20. A vehicular monitoring system comprising:
a brain box connected with a vehicle, wherein the brain box transmits vehicular data obtained from a plate tag on a license plate to a mainframe located away from the vehicle.

21. The vehicular monitoring system of claim 20, wherein the license plate is mounted on the brain box.

22. The vehicular monitoring system of claim 20, wherein the plate tag is a bar code or a radio frequency tag.

23. The vehicular monitoring system of claim 20, wherein the brain box comprises:
a plate scanner for obtaining the vehicular data from the plate tag;
a central processing unit in communication with the plate scanner;
memory in communication with the central processing unit for storing the vehicular data;
a transmitter in communication with the central processing unit for transmitting the vehicular data to the mainframe.

24. The vehicular monitoring system of claim 23, wherein the brain box further comprises a receiver in communication with the central processing unit for receiving mainframe data from the mainframe.

25. The vehicular monitoring system of claim 20 further comprising a license scanner located in the vehicle for obtaining the driver data from a license tag located on a driver's license, wherein the license scanner is in communication with the central processing unit.

26. The vehicular monitoring system of claim 20 further comprising:
a traffic control device located on an intelligent roadway and in communication with the brain box, wherein the traffic control device receives the vehicular data from the brain box.

27. The vehicular monitoring system of claim 20, wherein the traffic control device transmits location data to help determine the location and the speed of the vehicle.

28. The vehicular monitoring system of claim 27, wherein the traffic control device receives mainframe data and road data from the mainframe and transmits the mainframe data and road data to the brain box.

29. The vehicular monitoring system of claim 26 further comprising an electronic management station located near the intelligent roadway, wherein the electronic management station comprises memory and is in communication with the brain box and stores data received from the brain box in the memory.

30. A method for monitoring a vehicle comprising:
receiving vehicular data obtained from a plate tag on a license plate in a mainframe located away from a vehicle;
comparing the vehicular data to a database stored on the mainframe; and
transmitting mainframe data upon comparing the vehicular data, wherein the mainframe data includes instructions for reducing the speed of the vehicle or an ignition start procedure sequence for allowing the vehicle to operate.

31. The method of claim 30 further comprising:
receiving driver data obtained from a license tag on a driver's license in a mainframe located away from a vehicle.

32. The method of claim 31 further comprising:
comparing the driver data to a database stored on the mainframe; and
transmitting mainframe data upon comparing the driver data.

33. The method of claim 30 further comprising transmitting road data from the mainframe to a brain box.

34. The method of claim 33, wherein the road data comprises information indicating the current speed limit the vehicle 108 is allowed to travel.

35. The method of claim 1 further comprising transmitting driver data obtained from a license tag on a driver's license to a mainframe located away from the vehicle.
